(19) United States
(12) Patent Application Publication
(10) Pub. No.: US 2026/0016330 A1
(43) Pub. Date: Jan. 15, 2026

(54) CARTRIDGE FOR ULTRASONIC IRRADIATION DEVICE AND METHOD THEREFOR

(71) Applicant: JEISYS MEDICAL INC., Seoul (KR)

(72) Inventors: Kwang Hyeok Jung, Seoul (KR); Kwang Ho Ryu, Seoul (KR); Hyun Jin Kim, Seoul (KR)

(73) Assignee: JEISYS MEDICAL INC., Seoul (KR)

(21) Appl. No.: 19/326,954

(22) Filed: Sep. 12, 2025

Related U.S. Application Data
(63) Continuation of application No. PCT/KR2024/004435, filed on Apr. 4, 2024.

(30) Foreign Application Priority Data
Apr. 25, 2023 (KR) 10-2023-0053936

(51) Int. Cl. G01F 23/296; G01C 9/06

(52) U.S. Cl. CPC G01F 23/2961; G01C 9/06

(57) ABSTRACT

A cartridge for an ultrasonic irradiation device includes a housing in which an ultrasonic irradiator is provided to be immersed in a fluid; a measuring device provided on one side of the housing and configured to measure a resistance or impedance of the fluid; and a processor connected to the measuring device and configured to control the ultrasonic irradiator to apply a preset corresponding ultrasonic energy according to an evaporation state of the fluid based on the measured resistance or impedance of the fluid.

### CROSS-REFERENCE TO RELATED APPLICATIONS

The present application is a continuation of International Patent Application No. PCT/KR2024/004435, filed on Apr. 4, 2024, which claims the benefit of priority to Korean Patent Application No. 10-2023-0053936 filed on Apr. 25, 2023. The disclosures of the above-listed applications are hereby incorporated by reference herein in their entirety.

### FIELD

The present disclosure relates to a cartridge for an ultrasonic irradiation device and a method therefor.

### BACKGROUND

Ultrasound refers to waves with a frequency of 20 kHz or higher, and has the property of penetrating water, so it is widely used in the medical field, such as ultrasound diagnostic devices and ultrasound treatment devices.

An application of ultrasound in the medical field is an ultrasound imaging device that utilizes the properties of ultrasound penetration and reflection. For example, there is a device that visualizes the time and intensity of reflection as ultrasound penetrates the human body and passes through each organ, thereby obtaining a cross-sectional image of the human body.

In addition, there is a device that uses the heat generated by high-intensity focused ultrasound (HIFU) to burn and remove specific subcutaneous tissues, such as tumors in the skin, or to induce degeneration and regeneration of skin tissue, resulting in skin beauty or skin plastic surgery effects, such as wrinkle improvement.

In a conventional ultrasonic irradiation device, an irradiation is performed while a transducer is immersed in distilled water so that the transducer is not damaged.

However, the conventional ultrasonic irradiation device has limitations in efficiently irradiating ultrasound in the case of fluctuations such as the evaporation state, residual amount, and tilting state of distilled water, limitations in extending the life of the transducer, and limitations in preventing accidents caused by ultrasonic irradiation.

### SUMMARY

In an exemplary embodiment, the present invention provides a cartridge for an ultrasonic irradiation device. The cartridge comprises: a housing; an ultrasonic irradiator provided in the housing and immersed in a fluid; a measuring device provided on one side of the housing and configured to measure a resistance or impedance of the fluid; and a processor connected to the measuring device and configured to control the ultrasonic irradiator based on the measured resistance or impedance of the fluid, wherein the measured resistance or impedance of the fluid corresponds to a residual amount of the fluid.

### BRIEF DESCRIPTION OF THE FIGURES

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a diagram illustrating a configuration of a cartridge for an ultrasonic irradiation device according to the present disclosure.

FIG. 2 is a flowchart illustrating an example of an ultrasonic generation method according to the present disclosure.

FIG. 3 is a diagram illustrating an example of a process of measuring the resistance or impedance of a fluid through the measurement step of FIG. 2.

FIG. 4 is a flowchart illustrating another example of an ultrasonic generation method according to the present disclosure.

FIG. 5 is a diagram illustrating an example of a process of setting an irradiation limit angle based on the resistance or impedance of the fluid according to the depth through the measurement step and the control step of FIG. 4.

FIG. 6 is a flowchart illustrating another example of an ultrasonic generation method according to the present disclosure.

FIGS. 7 to 9 are diagrams illustrating an example of a process of measuring a tilt angle of at least one of a housing or a handpiece through the measurement step of FIG. 6.

FIG. 10 is a flowchart illustrating another example of an ultrasonic generation method according to the present disclosure.

FIGS. 11 to 13 are diagrams illustrating an example of a process of measuring at least one of a depth level or a tilt level of distilled water through the measuring step of FIG. 10.

### DETAILED DESCRIPTION

Exemplary embodiments of the present disclosure provide for efficiently irradiating ultrasound.

Exemplary embodiments of the present disclosure further provide for extending the life of a transducer.

Exemplary embodiments of the present disclosure further provide for preventing accidents due to ultrasonic irradiation.

Technical problems addressed by inventive concepts provided herein are not limited to the technical problems mentioned above, and other technical problems not mentioned will be clearly understood by those skilled in the art from the following description.

In an aspect of the present disclosure, a cartridge for an ultrasonic irradiation device may include a housing in which an ultrasonic irradiator is provided to be immersed in a fluid; a measuring device provided on one side of the housing and configured to measure a resistance or impedance of the fluid; and a processor connected to the measuring device and configured to control the ultrasonic irradiator to apply a preset corresponding ultrasonic energy according to an evaporation state of the fluid based on the measured resistance or impedance of the fluid.

Furthermore, the measuring device may be configured to measure the resistance or impedance of each depth of the fluid.

Furthermore, the processor may be configured to, based on at least one of the housing or a handpiece coupled with the housing being positioned within a preset irradiation limit angle according to a residual amount of the fluid, control the ultrasonic irradiator to apply ultrasound corresponding to the irradiation limit angle.

Furthermore, the measuring device may be further configured to measure a tilt angle of at least one of the housing or a handpiece coupled with the housing.

Furthermore, the measuring device may include an inertial measurement unit (IMU) to measure the tilt angle.

Furthermore, the IMU may be at least one of a gyro sensor or an acceleration sensor.

Furthermore, the processor may be further configured to, based on at least one of the housing or the handpiece being positioned within the preset irradiation limit angle according to the tilt angle, control the ultrasonic irradiator to apply ultrasound corresponding to the irradiation limit angle.

Furthermore, the measuring device may be further configured to measure at least one of a depth level or a tilt level of the fluid.

Furthermore, the measuring device may include a plurality of identical depth level sensors provided on both sides of an inside of the housing to measure at least one of the depth level or the tilt level of the fluid.

Furthermore, the processor may be further configured to, based on at least one of the housing or the hand piece being positioned within a preset irradiation limit angle according to the depth level and the tilt level of the fluid, control the ultrasonic irradiator to apply ultrasound corresponding to the irradiation limit angle.

Furthermore, in another aspect of the present disclosure, a method for ultrasonic irradiation performed by a cartridge for an ultrasonic irradiation device may include measuring a resistance or impedance of a fluid accommodated in a housing of the cartridge; and controlling an ultrasonic irradiator of the cartridge to apply a preset corresponding ultrasonic energy according to an evaporation state of the fluid based on the measured resistance or impedance of the fluid.

Furthermore, controlling the ultrasonic irradiator may include, based on at least one of the housing or a handpiece coupled with the housing being positioned within a preset irradiation limit angle according to a residual amount of the fluid, controlling the ultrasonic irradiator to apply ultrasound corresponding to the irradiation limit angle.

Furthermore, measuring the resistance or impedance of the fluid may further include measuring a tilt angle of at least one of the housing or a handpiece coupled with the housing, and controlling the ultrasonic irradiator may further include, based on at least one of the housing or the handpiece being positioned within the preset irradiation limit angle according to the tilt angle, controlling the ultrasonic irradiator to apply ultrasound corresponding to the irradiation limit angle.

Furthermore, measuring the resistance or impedance of the fluid may further include measuring at least one of a depth level or a tilt level of the fluid, and controlling the ultrasonic irradiator may further include, based on at least one of the housing or the hand piece being positioned within a preset irradiation limit angle according to the level and the tilt level of the fluid, controlling the ultrasonic irradiator to apply ultrasound corresponding to the irradiation limit angle.

Furthermore, a computer program stored in a computer-readable recording medium for executing an exemplary embodiment of a method according to the present disclosure may be further provided.

Furthermore, a computer-readable recording medium recording a computer program for executing an exemplary embodiment of a method according to the present disclosure may be further provided.

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network. Furthermore, when a certain part “includes” a certain element, other elements are not excluded unless explicitly described otherwise, and other elements may in fact be included.

Furthermore, when a certain part “includes” a certain element, other elements are not excluded unless explicitly described otherwise, and other elements may in fact be included.

In the entire specification of the present disclosure, when any member is located “on” another member, this includes a case in which still another member is present between both members as well as a case in which one member is in contact with another member.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

Hereinafter, operation principles and embodiments of the present disclosure will be described with reference to the accompanying drawings.

First, High Intensity Focused Ultrasound (HIFU) technology is the latest thermal ablation treatment that burns specific subcutaneous tissues such as tumors in the skin by using the heat generated when high-intensity ultrasound is focused on one point in the skin.

This is similar to the principle of focusing warm sunlight with a magnifying glass to light a fire. Since ultrasound easily passes through body tissues, HIFU treatment is performed in a completely non-invasive manner without a knife or even a needle. In other words, by simply pressing the patient's skin on the ultrasound generation surface, specific subcutaneous tissues such as tumors are burned and treated. In addition, HIFU treatment is currently being used to treat uterine fibroids, bone metastases, prostate cancer, breast cancer, pancreatic cancer, liver cancer, and kidney cancer.

This high-intensity focused ultrasound technology may be implemented through an ultrasonic irradiation device. The ultrasonic irradiation device can irradiate ultrasound to the surface of a patient's skin.

The controller of a cartridge for an ultrasonic irradiation device according to the present disclosure in this specification includes various devices that may perform computational processing and provide results to a user. For example, the controller of the ultrasonic irradiation device according to the present disclosure may include a computer, a server device, and a portable terminal, or may be in the form of one of them.

The computer may include, for example, a notebook, a desktop, a laptop, a tablet PC, a slate PC, and the like mounted with a web browser.

The server device is a server that communicates with an external device to process information, and may include an application server, a computing server, a database server, a file server, a mail server, a proxy server, and a web server.

A portable terminal is a wireless communication device that ensures portability and mobility, and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, a smart phone, and the like, and a wearable device such as at least one of a watch, a ring, bracelets, anklets, a necklace, glasses, contact lenses, or a head-mounted device (HMD).

A cartridge for an ultrasonic irradiation device according to the present disclosure may include a housing in which an ultrasonic irradiator is provided to be immersed in a fluid; a measuring device provided on one side of the housing and configured to measure a resistance or impedance of the fluid; and a processor connected to the measuring device and configured to control the ultrasonic irradiator to apply a preset corresponding ultrasonic energy according to an evaporation state of the fluid based on the measured resistance or impedance of the fluid.

The cartridge for an ultrasonic irradiation device may efficiently irradiate ultrasound, extend the life of a transducer, and prevent accidents caused by ultrasonic irradiation.

Hereinafter, the cartridge for an ultrasonic irradiation device will be described in detail.

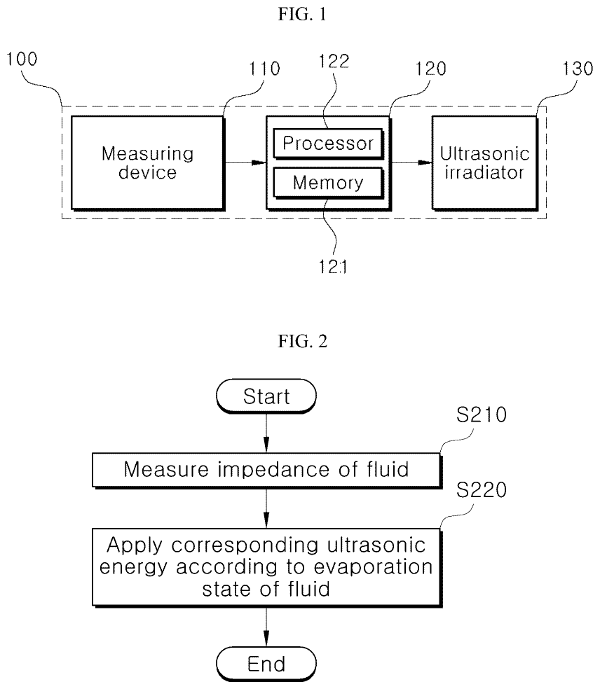

FIG. 1 is a diagram illustrating a configuration of a cartridge for an ultrasonic irradiation device according to the present disclosure.

Referring to FIG. 1, a cartridge for an ultrasonic irradiation device 100 may include a measuring device 110, a controller 120, and an ultrasonic irradiator 130.

The measuring device 110 may measure a resistance or impedance of a fluid, and may also measure the resistance or impedance separately for each depth of the fluid. In addition, the measuring device 110 may further measure a tilt angle of at least one of a housing or a handpiece, and may further measure at least one of a depth level or a tilt level of the fluid. For example, the fluid may be distilled water, and the like. In this case, distilled water means pure water from which all impurities have been substantially removed through a distillation process.

The controller 120 may be implemented with a memory 121 that stores data on an algorithm for controlling the operation of components within the device or a program that reproduces the algorithm, and at least one processor 122 that performs the aforementioned operation using the data stored in the memory 121. The memory 121 and the processor 122 may each be implemented as separate chips. In addition, the memory 121 and the processor 122 may also be implemented as a single chip.

The memory 121 may store data supporting various functions of the device, a program for the operation of the processor 122, may store input/output data, and may store a plurality of application programs or applications run on the device, data for the operation of the device, and commands. At least some of these application programs may be downloaded from an external server via wireless communication.

The memory 121 may include at least one type of storage medium among a flash memory type, a hard disk type, an SSD type (Solid State Disk type), an SDD type (Silicon Disk Drive type), a multimedia card micro type, a card type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In addition, the memory 121 may be a database that is separate from the device but connected by wire or wirelessly.

The processor 122 is connected to the measuring device 110 and may control the ultrasonic irradiator 130 to apply a preset corresponding ultrasonic energy according to an evaporation state of the fluid based on the measured resistance or impedance of the fluid. In addition, the processor 122 may control the ultrasonic irradiator 130 to apply ultrasound corresponding to the irradiation limit angle when at least one of the housing or the handpiece is positioned within the preset irradiation limit angle according to the residual amount of the fluid. In addition, the processor 122 may control the ultrasonic irradiator 130 to apply ultrasound corresponding to the irradiation limit angle when at least one of the housing or the handpiece is positioned within the preset irradiation limit angle according to the angle at which it is tilted. In addition, the processor 122 may control the ultrasonic irradiator 130 to apply ultrasound corresponding to the irradiation limit angle when at least one of the housing or the handpiece is positioned within the preset irradiation limit angle according to the depth level and the tilt level of the fluid.

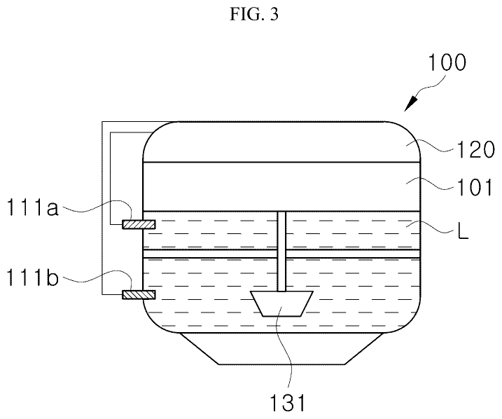

FIG. 2 is a flowchart illustrating an example of an ultrasonic generation method according to the present disclosure. FIG. 3 is a diagram illustrating an example of a process of measuring the resistance or impedance of a fluid through the measurement step of FIG. 2.

As shown in FIGS. 2 and 3, the ultrasonic generation method may include a measurement step S210 and a control step S220.

The measurement step may measure the resistance or impedance of the fluid L through the measuring device 110 (step S210). The measuring device 110 may be electrically connected to a PCB provided in the processor 122 and may include two resistance or impedance terminals 111a and 111b to measure the resistance or impedance of the fluid L. In this case, a housing 101 may be provided so that a transducer 131 of the ultrasonic irradiator 130 is immersed in the fluid L.

The control step may control the ultrasonic irradiator 130 to determine the evaporation state of the fluid L based on the measured resistance or impedance of the fluid L, determine whether the fluid is present in the transducer 131 based on the evaporation state, and apply ultrasonic energy in the case that the fluid is present (step S220). On the other hand, the processor 122 may control the ultrasonic irradiator 130 so as not to apply ultrasonic energy when the fluid is not present, and may also control the notification means to notify that the fluid is not present through at least one notification means including a voice speaker and an LED.

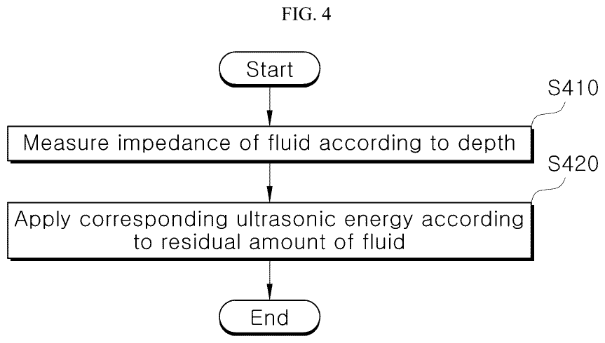

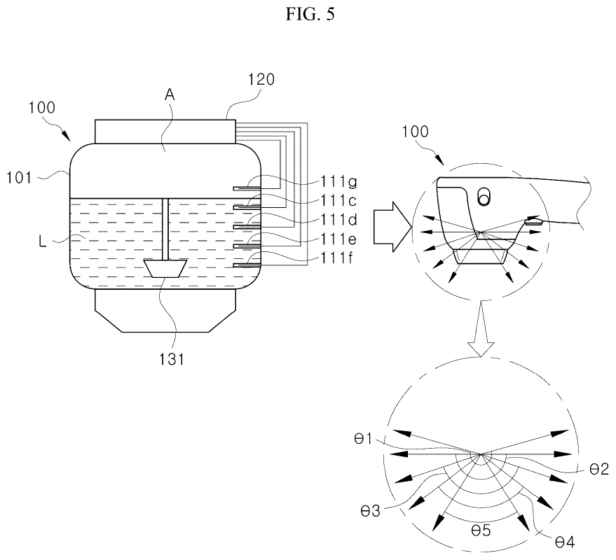

FIG. 4 is a flowchart illustrating another example of an ultrasonic generation method according to the present disclosure. FIG. 5 is a diagram illustrating an example of a process of setting an irradiation limit angle based on the resistance or impedance of the fluid according to the depth through the measurement step and the control step of FIG. 4.

As shown in FIG. 4 and FIG. 5, the ultrasonic generation method may include a measurement step S410 and a control step S420.

The measurement step may measure the resistance or impedance of the fluid L according to the depth through the measurement step 110 (step S410). The measuring device 110 is electrically connected to a PCB provided in the processor 122 and may include four resistance or impedance terminals 111c to 111f to measure resistance or impedance according to the depth of the fluid L. In addition, the measuring device 110 is electrically connected to a PCB provided in the processor 122 and may include a separate resistance or impedance terminal 111g to measure resistance or impedance of the air layer A. The number of resistance or impedance terminals is not limited to five, and may be less than five or more than six.

The control step determines the residual amount of the fluid L based on at least one of the measured depth-dependent resistance or impedance of the fluid L and the measured resistance or impedance of the air layer A through the processor 122, and in the case that at least one of the housing 101 or the handpiece coupled with the housing 101 is positioned within the preset irradiation limit angle according to the residual amount of the fluid L, the ultrasonic irradiator 130 may be controlled to apply ultrasound corresponding to the irradiation limit angle (step S420).

For example, in the case that the residual amount of the fluid L determined through the measurement of five resistance or impedance terminals 111c to 111g is a first reference amount that is set as a preset reference amount, and at least one of the housing 101 or the handpiece is positioned within a first irradiation limit angle that is set as a preset reference amount, the processor 122 may control the ultrasonic irradiator 130 to apply ultrasound corresponding to the first irradiation limit angle. The ultrasonic irradiator 130 may irradiate ultrasound corresponding to the first irradiation limit angle to the skin. The first irradiation limit angle θ1 may be a range in which irradiation is possible up to 240°. The processor 122 may also control the ultrasonic irradiator 130 to apply ultrasonic energy by gradually adjusting it to a preset intensity. The preset intensity may be at least one of a weak intensity, a medium intensity, or a strong intensity.

For another example, in the case that the residual amount of the fluid L determined through the measurement of the four resistance or impedance terminals 111c to 111f is a second reference amount that is less than the preset first reference amount, and at least one of the housing 101 or the handpiece is positioned within a preset second irradiation limit angle according to the second reference amount, the processor 122 may control the ultrasonic irradiator 130 to apply ultrasound corresponding to the second irradiation limit angle. The ultrasonic irradiator 130 may irradiate ultrasound corresponding to the second irradiation limit angle to the skin. The second irradiation limit angle θ2 may be in a range in which irradiation is possible up to 180°. The processor 122 may also control the ultrasonic irradiator 130 to apply ultrasonic energy by gradually adjusting it to a preset intensity. The preset intensity may be at least one of a weak intensity, a medium intensity, or a strong intensity.

For still another example, in the case that the residual amount of the fluid L determined through the measurement of three resistance or impedance terminals 111d to 111f is a third reference amount that is less than the preset second reference amount, and at least one of the housing 101 or the handpiece is positioned within the preset third irradiation limit angle according to the third reference amount, the processor 122 may control the ultrasonic irradiator 130 to apply ultrasound corresponding to the third irradiation limit angle. The ultrasonic irradiator 130 may irradiate ultrasound corresponding to the third irradiation limit angle to the skin. The third irradiation limit angle θ3 may be a range in which irradiation is possible up to 150°. The processor 122 may control the ultrasonic irradiator 130 to apply ultrasonic energy by stepwise adjusting it to a preset intensity. The preset intensity may be at least one of a weak intensity, a medium intensity, or a strong intensity.

As still another example, the processor 122 may control the ultrasonic irradiator 130 to apply ultrasound corresponding to the fourth irradiation limit angle when the residual amount of the fluid L determined through the measurement of the two resistance or impedance terminals 111e to 111f is a fourth reference amount that is less than the preset third reference amount, and at least one of the housing 101 or the handpiece is positioned within a fourth irradiation limit angle preset according to the fourth reference amount. The ultrasonic irradiator 130 may irradiate ultrasound corresponding to the fourth irradiation limit angle to the skin. The fourth irradiation limit angle θ4 may be a range that may be irradiated up to 120°. The processor 122 may control the ultrasonic irradiator 130 to apply ultrasonic energy by stepwise adjusting it to a preset intensity. The preset intensity may be at least one of a weak intensity, a medium intensity, or a strong intensity.

As still another example, the processor 122 may control the ultrasonic irradiator 130 to apply ultrasound corresponding to a fifth irradiation limit angle when the residual amount of the fluid L determined through the measurement of one resistance or impedance terminal 111f is a fifth reference amount that is less than the preset fourth reference amount, and at least one of the housing 101 or the handpiece is positioned within the preset fifth irradiation limit angle according to the fifth reference amount. The ultrasonic irradiator 130 may irradiate ultrasound corresponding to the fifth irradiation limit angle to the skin. The fifth irradiation limit angle θ5 may be a range in which irradiation is possible up to 90°. The processor 122 may control the ultrasonic irradiator 130 to apply ultrasonic energy by stepwise adjusting it to a preset intensity. The preset intensity may be at least one of a weak intensity, a medium intensity, or a strong intensity.

Meanwhile, the irradiation limit angle is not limited to five angle conditions, and may be variously set according to four or fewer angle conditions or six or more angle conditions.

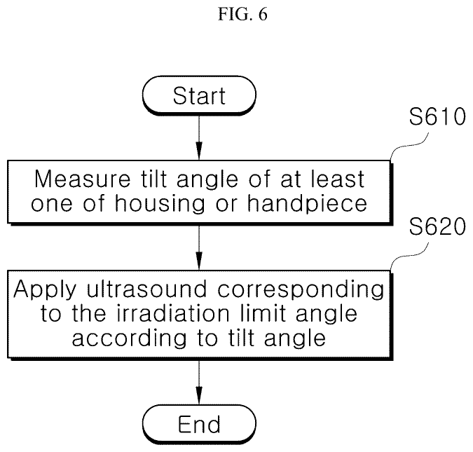

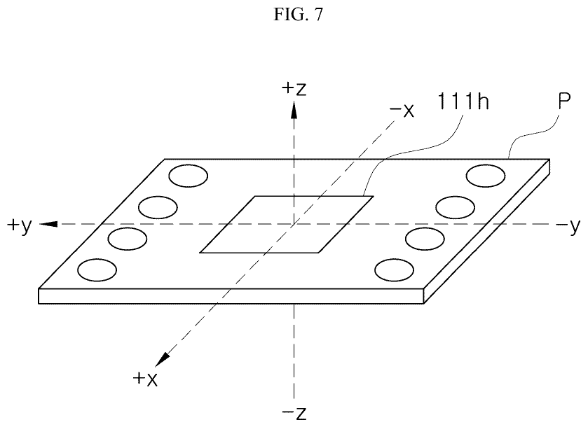

FIG. 6 is a flowchart illustrating another example of an ultrasonic generation method according to the present disclosure. FIGS. 7 to 9 are diagrams illustrating an example of a process of measuring a tilt angle of at least one of a housing or a handpiece through the measurement step of FIG. 6.

As shown in FIGS. 6 to 9, the ultrasonic generation method may include a measurement step S610 and a control step S620.

The measurement step may measure the tilt angle of at least one of the housing 101 or the handpiece 102 coupled with the housing 101 through the measuring device 110 (step S610). The measuring device 110 may include an inertial measurement unit (IMU) to measure the tilt angle.

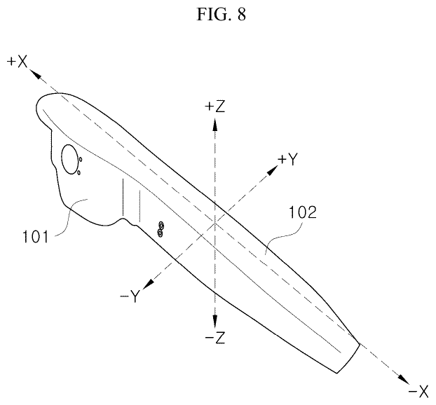

For example, the inertial measurement unit may be at least one of a gyro sensor or an acceleration sensor 111h. As shown in FIG. 7, the acceleration sensor 111h may be mounted on the PCB P, and as shown in FIG. 8, the PCB P may be provided in at least one of the inside of the handpiece 102 and the inside of the housing 101. The acceleration sensor 111h may detect the directions of the X-axis, Y-axis, and Z-axis of the handpiece 102, and may detect the directions of the X-axis, Y-axis, and Z-axis of the housing 101.

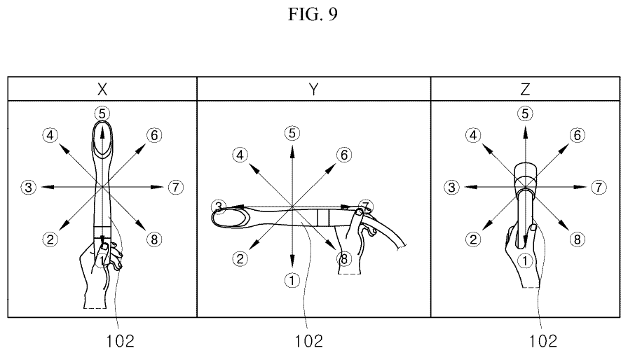

As shown in FIG. 9, the acceleration sensor 111h may obtain acceleration data for the directions of the X-axis, Y-axis, and Z-axis according to the angular position of the handpiece 102.

For example, the acceleration sensor 111h may obtain acceleration data for the 1st to 8th directions of the X-axis, acceleration data for the 1st to 8th directions of the Y-axis, and acceleration data for the 1st to 8th directions of the Z-axis.

The control step may control the ultrasonic irradiator 130 to apply ultrasound corresponding to the irradiation limit angle when at least one of the housing 101 or the handpiece 102 is positioned within a preset irradiation limit angle according to the tilt angle via the processor 122 (step S620).

For example, the processor 122 may control the ultrasonic irradiator 130 to apply ultrasound corresponding to a sixth irradiation limit angle when at least one of the housing 101 or the handpiece 102 is positioned within a preset sixth irradiation limit angle according to the tilt angle. The ultrasonic irradiator 130 may irradiate ultrasound corresponding to the sixth irradiation limit angle to the skin. The sixth irradiation limit angle may be a range in which irradiation is possible up to 240°, a range in which irradiation is possible up to 180°, a range in which irradiation is possible up to 150°, a range in which irradiation is possible up to 120°, and a range in which irradiation is possible up to 90°. The processor 122 may control the ultrasonic irradiator 130 to apply ultrasonic energy by gradually adjusting it to a preset intensity. The preset intensity may be at least one of a weak intensity, a medium intensity, or a strong intensity.

For example, in the case that the measured tilt angle is 180° and the sixth irradiation limit angle is set to a range of up to 180°, the processor 122 may control the ultrasonic irradiator 130 to apply the preset ultrasonic energy since it is an angle within the 180° range.

For another example, in the case that the measured tilt angle is 200° and the sixth irradiation limit angle is set to a range of up to 240°, the processor 122 may control the ultrasonic irradiator 130 to apply the preset ultrasound because the angle falls within the 240° range.

For still another example, in the case that the measured tilt angle is 250° and the sixth irradiation limit angle is set to a range of up to 240°, the processor 122 may control the ultrasonic irradiator 130 not to apply the ultrasound because the angle does not fall within the 240° range. Meanwhile, the irradiation limit angle is not limited to three angle conditions, and may be set in various ways according to two or fewer angle conditions or four or more angle conditions.

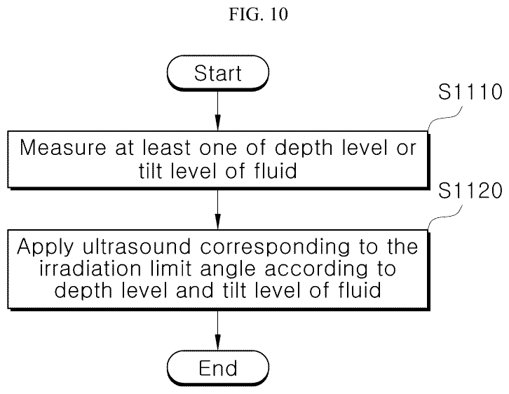

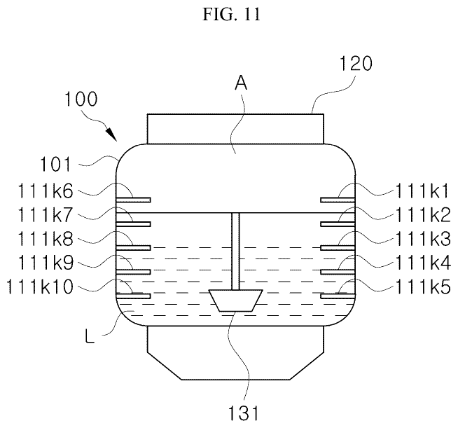

FIG. 10 is a flowchart illustrating another example of an ultrasonic generation method according to the present disclosure. FIGS. 11 to 13 are diagrams illustrating an example of a process of measuring at least one of a depth level or a tilt level of distilled water through the measuring step of FIG. 10.

As shown in FIGS. 11 to 13, the ultrasonic generation method may include a measuring step S1110 and a control step S1120.

The measuring step may measure at least one of the depth level or the tilt level of the fluid L through the measuring device 110 (step S1110). The measuring device 110 may include a plurality of identical depth level sensors 111kl to 111k10 provided on both sides of the inside of the housing 101 to measure at least one of the depth level or the tilt level of the fluid L. A plurality of identical depth level sensors 111kl to 111k10 may be provided at equal intervals on both sides of the inside of the housing 101. The number of plurality of identical depth level sensors is not limited to 10, and may be 8 or less or 12 or more.

For example, as shown in FIG. 11, the first depth level sensor 111kl and the sixth depth level sensor 111k6 may be provided at the same position on both sides of the inside upper portion of the housing 101, and the second depth level sensor 111k2 and the seventh depth level sensor 111k7 may be provided at the same position on both sides of the inside upper portion of the housing 101, but may be provided at a position lower than the positions of the first depth level sensor 111kl and the sixth depth level sensor 111k6.

In addition, the third depth level sensor 111k3 and the eighth depth level sensor 111k8 may be provided at the same position on both sides of the inner upper portion of the housing 101, but may be provided at a position lower than the positions of the second depth level sensor 111k2 and the seventh depth level sensor 111k7, and the fourth depth level sensor 111k4 and the ninth depth level sensor 111k9 may be provided at the same position on both sides of the inner upper portion of the housing 101, but may be provided at a position lower than the positions of the third depth level sensor 111k3 and the eighth depth level sensor 111k8.

In addition, the fifth depth level sensor 111k5 and the tenth depth level sensor 111k10 may be provided at the same position on both sides of the inner upper portion of the housing 101, but may be provided at a position lower than the positions of the fourth depth level sensor 111k4 and the ninth depth level sensor 111k9.

The control step may control the ultrasonic irradiator 130 to apply ultrasound corresponding to the irradiation limit angle when at least one of the housing 101 and the handpiece coupled with the housing 101 is positioned within the preset irradiation limit angle according to the level of the fluid L and the tilt level, through the processor 122.

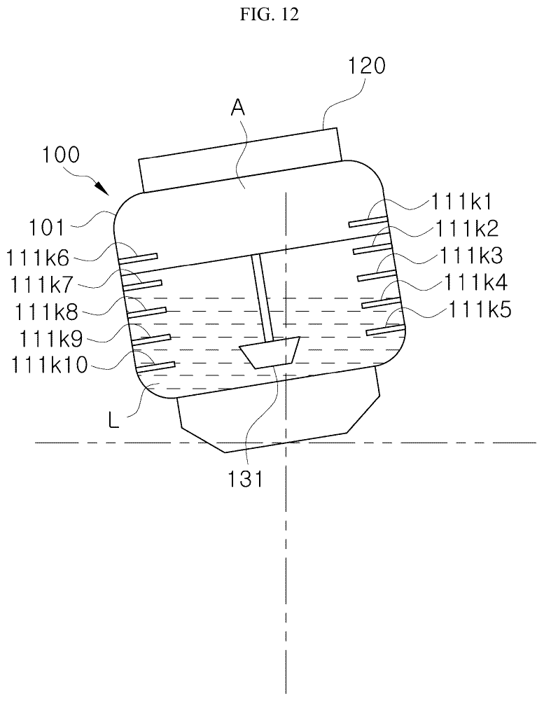

For example, as illustrated in FIG. 12, the processor 122 may control the ultrasonic irradiator 130 to apply ultrasound corresponding to a seventh irradiation limit angle when the depth level and the tilt level of the fluid L are detected through the fourth, fifth, eighth, ninth, and tenth level sensors 111k4, 111k5, 111k8, 111k9, 111k10, and at least one of the housing 101 or the handpiece is positioned within the seventh irradiation limit angle set according to the depth level and tilt level of the fluid. The ultrasonic irradiator 130 may irradiate ultrasound corresponding to the seventh irradiation limit angle to the skin. The seventh irradiation limit angle may be a range in which irradiation is possible up to 240°, a range in which irradiation is possible up to 180°, a range in which irradiation is possible up to 150°, a range in which irradiation is possible up to 120°, and a range in which irradiation is possible up to 90°. The processor 122 may control the ultrasonic irradiator 130 to apply ultrasonic energy by gradually adjusting it to a preset intensity. The preset intensity may be at least one of a weak intensity, a medium intensity, or a strong intensity.

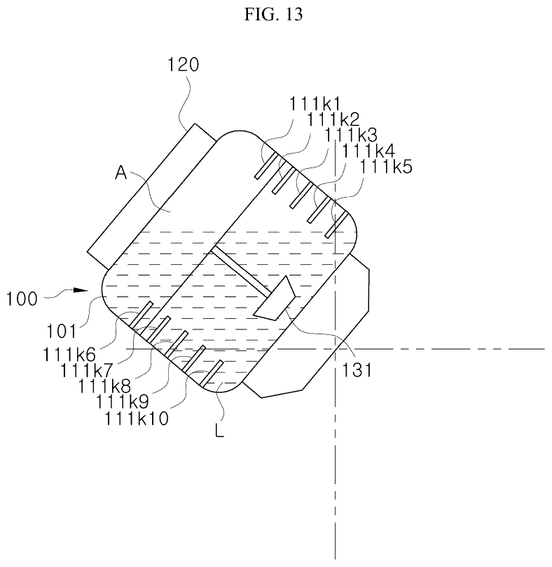

For another example, as illustrated in FIG. 13, the processor 122 may control the ultrasonic irradiator 130, to apply ultrasound corresponding to an eighth irradiation limit angle when the depth level and tilt level of the fluid L are detected through the fifth to tenth level sensors 111k5 to 111k10, and at least one of the housing 101 or the handpiece is positioned within the eighth irradiation limit angle narrower than the seventh irradiation limit angle set according to the depth level and tilt level of the fluid. The ultrasonic irradiator 130 may irradiate ultrasound corresponding to the eighth irradiation limit angle to the skin. The eighth irradiation limit angle may be a range in which irradiation is possible up to 240°, a range in which irradiation is possible up to 180°, a range in which irradiation is possible up to 150°, a range in which irradiation is possible up to 120°, or a range in which irradiation is possible up to 90°. The processor 122 may control the ultrasonic irradiator 130 to apply ultrasonic energy by stepwise adjusting it to a preset intensity. The preset intensity may be at least one of a weak intensity, a medium intensity, or a strong intensity.

Meanwhile, the irradiation limit angle is not limited to two angle conditions, and may be variously set according to three or more angle conditions.

Therefore, the cartridge 100 for the ultrasonic irradiation device according to the present disclosure may efficiently irradiate ultrasound, extend the life of the transducer, and prevent accidents due to ultrasonic irradiation.

At least one component may be added or deleted in accordance with the performance of the components illustrated in FIG. 1. In addition, it will be easily understood by those skilled in the art that the mutual positions of the components may be changed in accordance with the performance or structure of the system.

Although FIGS. 2, 4, 6, and 10 describe sequential execution of multiple steps, this is merely an exemplary description of the technical idea of the present embodiment, and a person having ordinary knowledge in the technical field to which the present embodiment belongs may modify and change the order described in FIGS. 2, 4, 6, and 10 without departing from the essential characteristics of the present embodiment, or may execute one or more of the multiple steps in parallel, thereby modifying and applying various modifications and variations. Therefore, FIGS. 2, 4, 6, and 10 are not limited to a sequential order.

As described above, the disclosed embodiments have been described with reference to the attached drawings. A person having ordinary knowledge in the technical field to which the present disclosure belongs will understand that the present disclosure may be implemented in a form different from the disclosed embodiments without changing the technical idea or essential features of the present disclosure. The disclosed embodiments are exemplary and should not be construed as limiting.

According to the above-described solutions of the present disclosure, an effect capable of efficiently irradiating ultrasound is provided.

In addition, according to the above-described solutions of the present disclosure, an effect capable of extending the life of a transducer is provided.

In addition, according to the above-described solutions of the present disclosure, an effect capable of preventing accidents due to ultrasonic irradiation is provided.

The effects of the present disclosure are not limited to the effects mentioned above, and other effects not mentioned will be clearly understood by those skilled in the art from the description.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A cartridge for an ultrasonic irradiation device, comprising:
a housing;
an ultrasonic irradiator provided in the housing and immersed in a fluid;
a measuring device provided on one side of the housing and configured to measure a resistance or impedance of the fluid; and
a processor connected to the measuring device and configured to control the ultrasonic irradiator based on the measured resistance or impedance of the fluid, wherein the measured resistance or impedance of the fluid corresponds to a residual amount of the fluid.

2. The cartridge according to claim 1, wherein the measuring device is configured to measure the resistance or impedance at a plurality of depth levels of the fluid.

3. The cartridge according to claim 1, wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle; and
based on the housing and/or the handpiece being positioned within the irradiation limit angle, controlling the ultrasonic irradiator to apply ultrasonic irradiation.

4. The cartridge according to claim 1, wherein the measuring device is further configured to measure a tilt angle of the housing and/or a handpiece coupled with the housing.

5. The cartridge according to claim 4, wherein the measuring device includes an inertial measurement unit (IMU) to measure the tilt angle.

6. The cartridge according to claim 5, wherein the IMU is at least one of a gyro sensor or an acceleration sensor.

7. The cartridge according to claim 4, wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured tilt angle; and
based on the housing and/or the handpiece being positioned within the irradiation limit angle, controlling the ultrasonic irradiator to apply ultrasonic irradiation.

8. The cartridge according to claim 1, wherein the measuring device is further configured to measure a depth level and/or tilt level of the fluid.

9. The cartridge according to claim 8, wherein the measuring device includes a plurality of depth level sensors provided on both sides of an inside of the housing to measure the depth level and/or tilt level of the fluid.

10. The cartridge according to claim 9, wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured depth level and/or tilt level of the fluid; and
based on the housing and/or the handpiece being positioned within the irradiation limit angle, controlling the ultrasonic irradiator to apply ultrasonic irradiation.

11. A method for ultrasonic irradiation performed by a cartridge for an ultrasonic irradiation device, comprising:
measuring, by a measuring device, a resistance or impedance of a fluid accommodated in a housing of the cartridge; and
controlling, by a processor connected to the measuring device, an ultrasonic irradiator of the cartridge based on the measured resistance or impedance of the fluid, wherein the measured resistance or impedance of the fluid corresponds to a residual amount of the fluid.

12. The method according to claim 11, wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle; and
based on the housing and/or the handpiece being positioned within the irradiation limit angle, controlling the ultrasonic irradiator to apply ultrasonic irradiation.

13. The method according to claim 11, further comprising:
measuring a tilt angle of the housing and/or a handpiece coupled with the housing;
wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured tilt angle; and
based on the housing and/or the handpiece being positioned within the irradiation limit angle, controlling the ultrasonic irradiator to apply ultrasonic irradiation.

14. The method according to claim 11, further comprising:
measuring a depth level and/or a tilt level of the fluid; and
wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured depth level and/or tilt level of the fluid; and
based on the housing and/or the handpiece being positioned within the irradiation limit angle, controlling the ultrasonic irradiator to apply ultrasonic irradiation.

15. A non-transitory computer-readable medium having processor-executable instructions stored thereon for ultrasonic irradiation performed by a cartridge for an ultrasonic irradiation device, wherein the processor-executable instructions, when executed, facilitate performance of the following:
measuring, by a measuring device, a resistance or impedance of a fluid accommodated in a housing of the cartridge; and
controlling, by a processor connected to the measuring device, an ultrasonic irradiator of the cartridge based on the measured resistance or impedance of the fluid, wherein the measured resistance or impedance of the fluid corresponds to a residual amount of the fluid.

16. The non-transitory computer-readable medium according to claim 15, wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle; and
based on the housing and/or the handpiece being positioned within the irradiation limit angle, controlling the ultrasonic irradiator to apply ultrasonic irradiation.

17. The non-transitory computer-readable medium according to claim 15, wherein the processor-executable instructions, when executed, further facilitate performance of the following:
measuring a tilt angle of the housing and/or a handpiece coupled with the housing;
wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured tilt angle; and
based on the housing and/or the handpiece being positioned within the irradiation limit angle, controlling the ultrasonic irradiator to apply ultrasonic irradiation.

18. The non-transitory computer-readable medium according to claim 15, wherein the processor-executable instructions, when executed, further facilitate performance of the following:
measuring a depth level and/or a tilt level of the fluid;
wherein controlling the ultrasonic irradiator based on the measured resistance or impedance of the fluid further comprises:
determining, based on the measured resistance or impedance of the fluid, an irradiation limit angle corresponding to the residual amount of the fluid;
determining whether or not the housing and/or a handpiece coupled with the housing is positioned within the irradiation limit angle according to the measured depth level and/or tilt level of the fluid; and
based on the housing and/or the handpiece being positioned within the irradiation limit angle, controlling the ultrasonic irradiator to apply ultrasonic irradiation.
